(19) United States
(12) Patent Application Publication
(10) Pub. No.: US 2019/0021340 A1
(43) Pub. Date: Jan. 24, 2019

(54) FLY REPELLENT, ITS PREPARATION METHOD AND ITS USE IN FLY REPELLENCY

(71) Applicant: Guangzhou Unique Biotechnology Co., Ltd., Guangzhou (CN)

(72) Inventors: Wenfeng Hu, Guangzhou (CN); Chujun Li, Guangzhou (CN); Lu Dong, Guangzhou (CN); Dou Hu, Guangzhou (CN)

(21) Appl. No.: 16/041,757

(22) Filed: Jul. 21, 2018

(30) Foreign Application Priority Data
Jul. 24, 2017 (CN) 201710606213.2
Aug. 8, 2017 (CN) 201710672261.1

(51) Int. Cl. A01N 63/02

(52) U.S. Cl. CPC A01N 63/02

(57) ABSTRACT

The present invention provides a fly repellent which comprises a by-product of breeding black soldier flies; the by-product comprises one or more of a pupal case of a black soldier fly, a corpse of an adult black soldier fly, and excrement of a black soldier fly. The fly repellent targets one or more types of flies including houseflies, anthomyiidae, blow flies, or flesh flies. In the present invention, a number of by-products produced during the breeding of black soldier flies are used to repel flies. The active ingredient in these by-products is fly-repelling pheromones, which could significantly decrease the lingering, foraging or ovipositioning of flies on livestock excrement, feeds or foods. The fly repellent made from the by-product of breeding black soldier flies or methods developed by using the by-product could be used in a farm environment, an animal body, a human living environment or a food processing factory.

### CROSS REFERENCE TO RELATED APPLICATIONS

The present application claims the benefit of Chinese Patent Application No. 201710672261.1 filed on Aug. 8, 2017, which claims the benefit of Chinese Patent Application No. 201710606213.2 filed on Jul. 24, 2017. All the above are hereby incorporated by reference.

### FIELD OF THE INVENTION

The invention belongs to the field of living and breeding environment improvement and protection; it relates to a fly repellent, its preparation method and its use in fly repellency.

### BACKGROUND OF THE INVENTION

Some flies, such as house flies and tachina flies, are important disease vectors. They carry many pathogenic microorganisms and can thus cause great harm to human beings and livestock (Wang Zeqing, Chen Shiqiang, et al., 2015). Among them, the housefly, Musca domestica L. (Diptera: Muscidae) is classified as an important pest in many parts of the world. The housefly frequently appears in human life and in places of human activities. It is also one of the most common fly species in livestock farms such as pig farms and chicken farms (Sinthusiri and Soonwera, 2014). The housefly likes to eat dirty excrements, and has a habit of spitting and defecating while eating. Furthermore, its hair and digestive tract contain a large number of germs, eggs and cysts of protozoans. Through the food intake of larvae, pathogens, eggs, and cysts of protozoans are passed from pupae to adult flies. At present, the housefly is known to carry around 40 types of bacteria and viruses, including various Bacillus species which cause diseases such as typhoid fever, paratyphoid fever, dysentery, tetanus, anthrax, tuberculosis and leprosy; and viruses which cause diseases such as poliomyelitis, trachoma and smallpox. The housefly could also carry parasitic cysts of protozoans, as well as roundworms, whipworms, hookworms, and tapeworm eggs. The larvae of houseflies could also parasite in digestive tracts, urethras, ear canals, purulent wounds, and inflammatory skins of human beings, causing Myiasis as accidental parasite (Ying Wu, 2004).

With the development of animal husbandry, there has been an increase in the number of intensive livestock and poultry farms. In small, individual farms, due to the lack of innocuous treatment of livestock and poultry excrements and the fact that some farms are relatively close to residential areas, the pollution posted by livestock and poultry farms on their surrounding residential environments has been increasing. This results in the breeding of harmful organisms; particularly, the breeding of flies have become a very serious problem.

In China, housefly control is mainly chemical control, supplemented by biological control. There are three major fly-repelling methods, including physical methods, chemical methods, and biological methods. These fly-repelling methods mainly disturb the flies' behavior; human beings and livestock are thus prevented from being affected by flies. However, various pesticides or herbs used in fly control are more or less harmful to human beings and other beneficial organisms. Some of these harms are irreversible, an example being the damage of animal nerves caused by organic phosphorus. In recent years, cyromazine has been widely added to animal feed to control the growth and development of fly maggots in animal houses. While good results have been achieved in improving the hygiene of livestock and poultry farms, cyromazine residues in animal products, such as eggs and meat, have been found due to many farmers using cyromazine for a prolonged period of time in egg-laying feeds and pig feeds without any withdrawal period. The problems associated with the use of chemical pesticides as well as the pressure of chemical pesticides posted on the environment have prompted the development of environmentally friendly fly control agents. Traditional fly control methods of using pesticides force a natural selection process which easily causes resistance in target pests.

At present, fly repellents sold in the Chinese domestic market mainly includes non-toxic fly repellents made from peppermint and ethyl alcohol, volatile mosquito/fly repellents made from essential oils containing active ingredients, and fly-repelling curtains. Some other products that are more rarely found include fly repellents made from reeds, a new type of multi-microbial live bacterial preparation, fly repellents made from materials containing Traditional Chinese Medicine ingredients, high-efficiency and slow-releasing electrothermal fly repellents, and modified PTFE fly repellents. The disadvantages of these products are: they contain substances that may be toxic to the human body. Therefore, in consideration of human health and environmental protection, most of the fly repellents listed above are unsuitable for circulating in the market.

Fly repellents from abroad mainly target fly eggs by inhibiting their growth; they also kill harmful insects by trapping with bait. Window stickers are used to attract and kill insects; high-intensity light is used to attract, move or capture insects; hot water or hot air devices are used to control insects found on grasslands; agricultural fly-capturing nets, water-insoluble porous polymer materials, pest control devices, among others are used to control flies. Further measures include using steamed soy sauce or soybean paste as bait to trap and kill flies.

Compared with domestic fly repellents, fly control technology from abroad is maturing and has shown a trend of diversified development. Most domestic fly repellent manufacturers and developers do not consider issues such as cost, environmental impact, and resource recycling when developing fly repellents. An excessive amount of toxic and harmful medical substances and pesticides are used, leading to serious impacts on the living environment and human health. On the other hand, some of the fly repelling products from abroad, such as insect-trapping laser devices from the United States and non-toxic insect and weed control devices from Japan are high in cost and not conducive to widespread use and circulation in the market.

Therefore, the society is in urgent need of a fly control method that employs effective biological control methods, is environmentally friendly, does not lead to resistance in flies, is not toxic to the human body, is easy to manufacture and low in cost, and can overcome the shortcomings of the prior art.

### SUMMARY OF THE INVENTION

The objective of the present invention is to provide a fly repellent that overcomes the deficiencies of the prior art.

Another objective of the present invention is to provide a preparation method for the fly repellent mentioned above.

Yet another objective of the present invention is to provide a use of the fly repellent mentioned above.

Through long-term experiments, the applicant found that by using by-products obtained during the breeding of black soldier flies in fly control, the frequency of flies lingering or foraging in livestock excrement or livestock feeds can be significantly reduced. Meanwhile, these by-products can be effectively reused. As no chemical treatment is involved in the treatment process, it is eco-friendly, the pests are not susceptible to drug resistance, and wastes can be continuously reused. This is also an innovative way of using the by-products of breeding black soldier flies.

The objectives of the present invention are achieved by the following technical solutions.

A fly repellent comprising a by-product of breeding black soldier flies; the by-product of breeding black soldier flies includes one or more of a pupal case of a black soldier fly, a corpse of an adult black soldier fly, and excrement of a black soldier fly.

The adult black soldier fly has gray and black wings and degraded mouthparts. Its body is mainly black, with a body length of between 15 mm to 20 mm. The abdomen region of a female adult black soldier fly is slightly reddish in color; each of the two sides of its second abdominal segment has a white translucent spot. The abdomen region of a male adult black soldier fly is aeneous. Black soldier flies are large in size: a mature black soldier fly larva is around ten times as heavy as a housefly larva.

The pupal case of a black soldier fly is dark brown in color. It is a coarctate pupa formed by molting of the final larval instar. The pupa can be seen when the pupal case is cut open.

The excrement of a black soldier fly is excrement produced during the breeding of the black soldier fly.

When experimenting with one or more of the by-products of breeding black soldier flies mentioned above, fly repelling effects were observed.

The fly repelling effects exhibit by the present invention is associated with fly-repelling pheromones, which have certain fly repelling effects.

Insect pheromones have long been used to control pests. The development of this technology started from the 1960s. Insect pheromones are chemical substances released by insects from their body for information transmission. They cause strong behavioral responses in other members of the same species. Examples of insect pheromones include sex pheromones, aggregation pheromones, trace pheromones, alarm pheromones, dispersal pheromones, among others. At present, more than 2,000 types of insect pheromones and analogues of insect pheromones have been identified and synthesized, and more than 100 types of insect pheromones have been commercially produced abroad. The most studied insect pheromones are those of the Lepidopteran species.

The application of pheromones in pest control has important prospects. The applicant discovered that there is a relatively high concentration of volatile substances in the excrement, pupae cases, and corpses of adult black soldier flies. Through experiments, it was found that these substances have good repellent effects on flies, and these substances are called “fly-repelling pheromones”. Nowadays, the research and application of pheromones have become increasingly important in fly control. Pheromones have a number of advantages including being more selective than chemical pesticides, highly sensitive, environmentally friendly, difficult to develop drug resistance, non-toxic, among others. The use of black soldier fly pheromones to repel flies could effectively reduce the density of flies, the lingering of flies on livestock excrement, and the harm caused by chemical control. Therefore, by preparing products that contain fly-repelling pheromones to repel flies, environmental requirements and toxicity requirements can be met. The use of fly pheromones in fly control has great advantages and vast potential for future development.

Preferably, the fly repellent comprises the following components:

0 wt %-50 wt % of the pupal case of a black soldier fly, 0 wt %-40 wt % of the corpse of an adult black soldier fly, and 20 wt %-100 wt % of the excrement of a black soldier fly.

More preferably, the fly repellent comprises the following components:

10 wt %-40 wt % of the pupal case of a black soldier fly, 10 wt %-40 wt % of the corpse of an adult black soldier fly, and 40 wt %-60 wt % of the excrement of a black soldier fly.

Most preferably, the fly repellent consists of the following components in a ratio of the pupal case of a black soldier fly:the corpse of an adult black soldier fly:the excrement of a black soldier fly=20%:30%:50% in percentage by weight.

Preferably, the fly repellent targets one or more types of flies including houseflies, anthomyiidae, blow flies, or flesh flies.

The present invention also protects a preparation method of the fly repellent, including drying and grounding the by-product of breeding black soldier flies to obtain the fly repellent.

The present invention also protects a method of repelling a target insect, comprising administering to a fly an effective amount of the fly repellent.

Preferably, the method comprises directly applying more than 50.0 g of the fly repellent on a surface in an environment in which the target insect of the fly repellent is lingering; the surface has an area of 120 cm². For example, more than 50.0 g of the fly repellent is sprayed direly on feeds or other surfaces with an area of 120 cm² to achieve the best repellency effect.

Furthermore, the method comprises applying the fly repellent to a farm environment, an animal body, a human living environment or a food processing factory.

Furthermore, the fly repellent of the present invention can be conveniently distributed and used by preparing it into a different form, including the form of an emulsion, a powder, a liquid, an ointment, a tincture, a cream, an aerosol or a tablet.

For example, the pupal case of a black soldier fly, the corpse of an adult black soldier fly, and excrement of a black soldier fly are dried, mixed and prepared into a fly repelling liquid, solid fly repelling incense, or a fly repelling candle by conventional methods. Good fly repellency has been observed.

According to the present invention, after the by-product of breeding black soldier flies is mixed, crushed, and directly applied on livestock excrement, the number of flies lingering on livestock excrement is drastically reduced. Comparing with blank experiments, the fly repellent of present invention exhibits a significant fly-repelling effect of reducing the number of flies by 90% or more.

According to the present invention, after the by-product of breeding black soldier flies is mixed, crushed, and directly applied on livestock feeds, the number of flies lingering on livestock feeds is drastically reduced. Comparing with blank experiments, the fly repellent of present invention exhibits a significant fly-repelling effect of reducing the number of flies by 90% or more.

The fly repellent provided by the present invention can be further prepared into an electrothermal fly repelling liquid, fly repelling incense or other products. These products can either be connected to electricity and heated, or ignited in a farm environment. For example, they can be used in human living rooms or livestock breeding environments such as farm barracks, ponds, or grasslands. They can effectively repel flies in these environments, thus preventing flies from disturbing people and affecting livestock breeding environments.

Comparing with the prior art, the advantages and beneficial effects of the present invention are as follows:

1. After long periods of observation and experimentation, the applicant discovered that the by-products of breeding black soldier flies contain fly-repelling pheromones, which impart significant fly repelling effects, and prevent the lingering of flies in livestock excrement or feeds.

2. The present invention provides an ecologically sustainable route for recycling and reusing by-products of breeding black soldier flies. As the recycling and reusing processes do not involve any chemical treatment, they are therefore eco-friendly, and the pests are not susceptible to chemical resistance. Sustainable waste recycling can be achieved.

3. In the present invention, the by-products of breeding black soldier flies can be further prepared into a variety of products. The preparation process is simple; the products obtained are easy to use and distribute, and do not cause any harm to human beings and livestock. The present invention provides an economical and ecologically friendly method for the utilization of livestock feeds and the treatment of livestock excrement.

### DETAILED DESCRIPTION OF THE ILLUSTRATED EMBODIMENTS

The present invention is further described below in combination with detailed embodiments. The embodiments do not limit the present invention in any form. Unless otherwise specified, the reagents, methods, and devices employed in the present invention are conventional reagents, methods, and devices in the art.

Unless otherwise specified, reagents and materials used in the present invention are all commercially available.

The technical solutions and technical effects of the present invention will be explained in detail in the following embodiments. However, the present invention is not limited to the following embodiments.

### Embodiments 1-3: Testing the Fly Repelling Effects on Livestock Excrement (Direct Spray)

By-products of breeding black soldier flies, including pupal cases, corpses of adult black soldier flies, and excrement are respectively dried, grounded, and mixed according to specified mass percentages.

Test procedures are as follows:

A. Four 50×50×50 cm rectangular-shaped net cages were prepared, and respectively denoted by X₁, Y₁, X₂ and Y₂. They are paired into two pairs. The two net cages denoted by X₁ and Y₁ were designated as the blank group, and the other two net cages denoted by X₂ and Y₂ were designated as the test group. A hole was punched in one face of each of the net cages, and two holes of two net cages were connected by a transparent hose to form a semi-enclosed net cage device. The device was placed in a ventilated room.

B. 50.0 g of the mixture mentioned above was uniformly sprayed on a plastic PP lunch box containing 150.0 g livestock excrement and with a surface area of 120 cm²; the plastic PP lunch box was placed in net cage X₂ described in step A. Another plastic PP lunch box containing 150.0 g livestock excrement and with a surface area of 120 cm² was placed in net cage X₁. Net cage X₁ was connected to net cage Y₁; net cage X₂ was connected to net cage Y₂. No houseflies were able to fly out from these connected net cages. Then, a total of 200 houseflies were released into each pair of net cages.

C. The activities of the houseflies were observed for 1 hour. The numbers of flies flying to net cages Y₁ and Y₂ were recorded; The housefly repellency rate was calculated using the formula below:

$$Housefly repellency rate = \frac{No . of flies in net cage {Y}_{2} - No . of flies in net cage {Y}_{1}}{Total No . of flies released into the pair of net cages} \times 100 \%$$

D. Steps A and C were repeated for 4 times for each embodiment. Average housefly repellency rate was calculated by averaging the 5 housefly repellency rates obtained.

In embodiments 1-3, the houseflies were adult black soldier flies collected on the fourth day after emergence, half male and half female.

For example, embodiment 1 in Table 1 shows the average housefly repellency rate of a fly repellent comprising 20% of pupal cases of black soldier flies, 20% of corpses of adult black soldier flies, and 60% of excrement of black soldier flies.

TABLE 1
the Constituents of Embodiments 1-3 and Their Average Housefly
Repellency Rates

| | | Corpses of | | Average |
|---|---|---|---|---|
| | | adult black | | Housefly |
| | Pupal | soldier flies | Excrement | repellency rate |
| Embodiment | cases (%) | (%) | ( % ) | (%) |
| Blank | 0 | 0 | 0 | 0 |
| group* | | | | |
| 1 | 20 | 20 | 60 | 96.4 |
| 2 | 20 | 40 | 40 | 95.1 |
| 3 | 20 | 60 | 20 | 92.5 |

*The housefly repellency rate of the blank group is calculated using the following formula
Housefly repellency rate of the blank group =
$\frac{No . of flies in net cage {Y}_{1}}{Total No . of flies released into the pair of net cages } \times 100 \%$

It can be seen from Table 1 that embodiments 1 to 3 showed significant housefly repellency, among which embodiment 1 showed the most significant housefly repellency, with an average repellency rate of 96.4%.

### Embodiments 4-6

Test procedures were the same as the procedure described in embodiment 1. Table 2 shows the average housefly repellency rates of fly repellents with different mixing ratios of pupal cases, corpses and excrement.

TABLE 2
the Constituents of Embodiments 4-7 and Their Average Housefly
Repellency Rates

| | Pupal | Corpses of adult | | Average Housefly |
|---|---|---|---|---|
| | cases | black soldier flies | Excrement | repellency rate |
| Embodiment | (%) | (%) | (%) | (%) |
| Blank group | 0 | 0 | 0 | 0 |
| 4 | 10 | 30 | 60 | 98.6 |
| 5 | 30 | 30 | 40 | 96.1 |
| 6 | 50 | 30 | 20 | 92.2 |

It can be seen from Table 2 that embodiments 4 to 6 showed significant housefly repellency, among which embodiment 4 showed the most significant housefly repellency, with an average repellency rate of 98.6%.

### Embodiments 7-9

Test procedures were the same as the procedure described in embodiment 1. Table 3 shows the constituents of fly repellents used in embodiments 4-7, and the average housefly repellency rates of embodiments 4-7.

TABLE 3
the Constituents of Embodiments 7-9 and Their Housefly Repellency
Rates

| | Pupal | Corpses of adult | | Average Housefly |
|---|---|---|---|---|
| | cases | black soldier flies | Excrement | repellency rate |
| Embodiment | (%) | (%) | (%) | (%) |
| Blank group | 0 | 0 | 0 | 0 |
| 7 | 40 | 10 | 50 | 97.4 |
| 8 | 30 | 20 | 50 | 98.7 |
| 9 | 20 | 30 | 50 | 100 |

It can be seen from Table 3 that embodiment 9 showed the best housefly repellency. The mixture of embodiment 9 consists of 20 wt % of pupal cases of black soldier flies, 30 wt % of corpses of adult black soldier flies, and 50 wt % of excrement of black soldier flies; it showed an average housefly repellency rate of 100%.

### Embodiments 10-12

Test procedures were the same as the procedures described in embodiment 1. Table 4 shows average housefly repellency rates of fly repellents that consist of only pupal cases of black soldier flies, corpses of adult black soldier flies, or excrement of black soldier flies.

TABLE 4
the Constituents of Embodiments 10-12 and Their Average Housefly
Repellency Rates

| | Pupal | Corpses of adult | | Average Housefly |
|---|---|---|---|---|
| | cases | black soldier flies | Excrement | repellency rate |
| Embodiment | (%) | (%) | (%) | (%) |
| Blank group | 0 | 0 | 0 | 0 |
| 10 | 100 | 0 | 0 | 80.8 |
| 11 | 0 | 100 | 0 | 72.6 |
| 12 | 0 | 0 | 100 | 92.5 |

It can be seen from Table 4 that the housefly repelling effects of the repellents consisting of pupal cases or corpses were not as good as the repellents consisting of excrement. Combining the results from Tables 1 to 4, it can be seen that a 100% average repellency rate is achieved in embodiment 9; the fly repellent used in this embodiment contained the pupal cases, the corpses and the excrement in a ratio of 20%:30%:50% (in mass percentage). It is thus understood that the by-products of breeding black soldier flies contain a certain amount of fly-repelling pheromones.

### Embodiment 13: Testing Fly Repellency on Livestock Feeds

In embodiments 13, the mixture containing fly-repelling pheromones were prepared using 20 wt % of pupal cases of black soldier flies, 30 wt % of corpses of adult black soldier flies, and 50 wt % of excrement of black soldier flies. The houseflies were adult black soldier flies collected on the fourth day after emergence, half male and half female.

The test was carried out under the same environmental conditions as described in embodiment 1. The test procedures were the same, except that different masses of mixtures containing fly-repelling pheromones were added to three plastic PP lunch boxes, each with a surface area of 120 cm², and each contained 150.0 g of commercially available fish feeds. Different amounts of mixtures were applied on the fish feeds, and average housefly repellency rates were calculated according to the method described in embodiment 1. The results are shown in Table 5 below.

TABLE 5
Average Housefly Repellency Rates of Applying Different Masses of
the Mixture

| | Average Housefly repellency |
|---|---|
| The mass of the mixture/g | rate/% |
| 30.0 | 94.6 |
| 50.0 | 100 |
| 70.0 | 100 |
| 90.0 | 100 |

It can be concluded from the results in Table 5 that when the mixture containing fly-repelling pheromones comprises the pupal cases, the corpses and the excrement in a ratio of 20%:30%:50% in mass percentage, the best fly repelling effect was achieved by directly applying 50.0 g or more of the mixture on the feeds: the average housefly repellency rate reached 100%.

### Embodiment 14: The Preparation of an Electrothermal Fly-Repelling Liquid from by-Products of Breeding Black Soldier Flies

The fly-repelling liquid of the present embodiment is prepared by heating with a heater. Its active ingredient extract is a yellow transparent liquid containing fly-repelling pheromones. The active ingredient extract is extracted using ethanol from by-products of breeding black soldier flies in a ratio of 20%:30%:50% in mass percentage (pupal cases of black soldier flies: corpses of adult black soldier flies: excrement of black soldier flies).

The procedure of extracting the active ingredient extract is as follows:

The following ingredients were respectively grounded and then mixed: 20.0 g of pupal cases of black soldier flies, 30.0 g of corpses of adult black soldier flies and 50.0 g of excrement of black soldier flies. The mixture obtained was then extracted 2 to 3 times with ethanol. 100 mL of the extracted liquid was saved for later use. The active ingredient extract, a reagent which modifies volatility, a C14 solvent and an auxiliary agent were weighed and mixed at a weight ratio of 1:1:1:1 and mixed in order to prepare the fly-repelling liquid containing fly-repelling pheromones. The fly-repelling liquid prepared was filled into a 50-mL vial, a wick was placed into the vial, and the vial was sealed by a cap. The vile was placed on a heater to produce the electrothermal fly-repelling liquid.

After testing, the above-mentioned electrothermal fly-repelling liquid was found to be capable of being heated to evaporate for 4 hours. The fly-repelling liquid that has not been heated to evaporate had a distinct smell of the insect; after heating and evaporation, the fly-repelling liquid did not have the distinct smell of the insect.

A fly repellency test was carried out using the same houseflies according to the method described in embodiment 1.

The result showed that no flies were present in the test net cages. The average repellency rate was 100%.

The electrothermal fly-repelling liquid of the present invention has good housefly repelling effects. It only needs to be connected to electricity, heated, and placed in locations where flies breed and linger; significant fly repelling effects would then be observed, the flies would no longer linger in livestock excrement.

### Embodiment 15: The Preparation of Fly-Repelling Incense from by-Products of Breeding Black Soldier Flies

The fly-repelling incense of the present invention is a mugwort-containing flammable substrate with a length of 15.0 cm, a radius of 2.0 cm and a mass of 15.0 g. The fly-repelling incense was prepared by mixing and pressing 20.0 g of pupal cases of black soldier flies, 30.0 g of corpses of adult black soldier flies and 50 g of excrement of black soldier flies. The pupal cases, the corpses and the excrement were dried, grounded, and mixed with 10 g of a mixture containing rice husk powder and pine wood chips mixed in a mass ratio of 1:1, to prepare the fly-repelling incense containing fly-repelling pheromones.

After testing, the above-mentioned fly-repelling incense was found to be capable of burning for 3 hours. The fly-repelling incense that has not been burned had a distinct smell of the insect; after burning, the fly-repelling liquid did not have the distinct smell of the insect. The houseflies were adult black soldier flies collected on the fourth day after emergence, half male and half female. A fly repellency test was carried out.

The procedure of the fly repellency test was as follows: five portions of 1.0 kg fresh livestock excrement was prepared and placed in five 60×40 cm large plastic containers. The containers were placed in an open field, separated from each other by a distance of 10.0 m. A blank group, a control group, and three experimental groups were set up. One stick of fly-repelling incense was ignited beside each of the containers of the experimental groups. One stick of odorless incense was ignited beside the container of the control group, and no incense was ignited beside the container of the blank group. The housefly repelling activity was observed, and the average housefly repellency rate was calculated. After the test, it was found that the housefly repellency rate of the blank group was 0, the housefly repellency rate of the control group was 52.3%, and the average housefly repellency rate of the experimental groups was 94.2%. It can be concluded that during the three hours of the burning of the odorless incense, a certain level of housefly repellency was observed, which may be attributed to light or heat, etc. However, the housefly repellency rate was low, and the fly repelling effect is far less significant than that of the fly-repelling incense.

The results show that the fly-repelling incense of the present embodiment demonstrated good housefly repelling effects. The fly-repelling incense of the present invention only needs to be ignited, placed in locations where flies breed and linger, and the lingering of flies in livestock excrement can be significantly reduced.

### Embodiment 16: The Preparation of a Fly-Repelling Candle from by-Products of Breeding Black Soldier Flies

The fly-repelling candle of the presence invention is a truncated cone-shaped ignitable candle with a length of 2.0 cm, a radius of 4.0 cm and a mass of 40.0 g. The fly-repelling candle was prepared by respectively drying and grounding 20.0 g of pupal cases of black soldier flies, 30.0 g of corpses of adult black soldier flies and 50 g of excrement of black soldier flies, followed by mixing. Ethanol was used to extract the mixture obtained for 2-3 times. 10.0 g of the liquid extract obtained was mixed with 30.0 g of odorless white wax to obtain a 40-gram fly-repelling candle containing fly-repelling hormones.

After testing, the above-mentioned fly-repelling candle was found to be capable of burning for 4 hours. The fly-repelling candle that has not been burned had a distinct smell of the insect; after burning, the fly-repelling candle did not have the distinct smell of the insect. The houseflies were adult black soldier flies collected on the fourth day after emergence, half male and half female.

A fly repellency test was carried out, its procedure was as follows:

A. Six 50×50×50 cm³ rectangular-shaped net cages were prepared, and respectively denoted by a₁/a₂, b₁/b₂ and c₁/c₂. A hole was punched in one face of each of the net cages, and two holes of two corresponding net cages were connected by a transparent hose to form a semi-enclosed net cage device. The device was placed in a ventilated room.

B. A group of 200 houseflies were bred in net cages a₁, b₁ and c₁ of step A. Two corresponding net cages were connected to ensure that no housefly could fly out.

C. Fly-repelling candles and odorless white candles were respectively ignited next to net cages a₁ and b₁ which bred houseflies according to step B. No candles were lit beside net cage c₁. After 4 hours, the fly-repelling candles were burned out. The activities of the houseflies were observed; the numbers of flies flying away from the fly-repelling candles and towards net cages a₂, b₂, and c₂ were recorded. Housefly repellency rates were calculated and the test results are shown in Table 6 below.

TABLE 6
Comparing the Housefly Repellency Rates under the
Condition of Embodiment 16

| | Testing time/h | | | | |
|---|---|---|---|---|---|
| | 0.5 | 1 | 2 | 3 | 4 |
| The number of houseflies in net cage | 196 | 200 | 200 | 200 | 200 |
| a₂ | | | | | |
| Housefly repellency rate/% | 98.0 | 100 | 100 | 100 | 100 |
| The number of houseflies in net cage | 62 | 54 | 50 | 66 | 70 |
| b₂ | | | | | |
| Housefly repellency rate/% | 31.0 | 27.0 | 25.0 | 33.0 | 35.0 |
| The number of houseflies in net cage | 89 | 94 | 99 | 107 | 96 |
| c₂ | | | | | |
| Housefly repellency rate/% | 44.5 | 47.0 | 49.5 | 53.5 | 48.0 |

Table 6 shows that during the 4 hours of the burning of the fly-repelling candles, the housefly repellency rate reached 98.0% after 0.5 hours, and then reached 100% after another 0.5 hours. During the four hours of the burning of an ordinary odorless white candle, housefly repellency was also observed, which may be attributed to light, heat, etc. However, the housefly repellency rate was much lower comparing to using fly-repelling candles. For the blank group, the number of houseflies on either side was basically the same; the housefly repellency rate was around 50%.

The results show that the fly-repelling candle of the present embodiment demonstrates good housefly repelling effects. The fly-repelling candle of the present invention only needs to be ignited, placed in locations where flies breed and linger, and the lingering of flies in livestock manure can be significantly reduced.

What is claimed is:

1. A fly repellent comprising a by-product of breeding black soldier flies; wherein the by-product of breeding black soldier flies comprises one or more of a pupal case of a black soldier fly, a corpse of an adult black soldier fly, and excrement of a black soldier fly.

2. The fly repellent according to claim 1, wherein the fly repellent comprises the following components: 0 wt %-50 wt % of the pupal case of a black soldier fly, 0 wt %-40 wt % of the corpse of an adult black soldier fly, and 20 wt %-100 wt % of the excrement of a black soldier fly.

3. The fly repellent according to claim 1, wherein the fly repellent comprises the following components: 10 wt %-40 wt % of the pupal case of a black soldier fly, 10 wt %-40 wt % of the corpse of an adult black soldier fly, and 40 wt %-60 wt % of the excrement of a black soldier fly.

4. The fly repellent according to claim 3, wherein the fly repellent consists of the following components in a ratio of the pupal case of a black soldier fly:the corpse of an adult black soldier fly:the excrement of a black soldier fly=20%:30%:50% in percentage by weight.

5. The fly repellent according to claim 1, wherein the fly repellent targets one or more types of flies including houseflies, anthomyiidae, blow flies, or flesh flies.

6. A preparation method of the fly repellent according to claim 1, including drying and grounding a by-product of breeding black soldier flies to obtain the fly repellent.

7. A method of repelling a target insect, comprising administering to a fly an effective amount of the fly repellent according to claim 1.

8. The method of repelling the target insect according to claim 7, comprising directly applying more than 50.0 g of the fly repellent on a surface in an environment in which the target insect of the fly repellent is lingering; the surface has an area of 120 cm².

9. The method of repelling the target insect according to claim 7, comprising applying the fly repellent to a farm environment, an animal body, a human living environment or a food processing factory.

10. The method of repelling the target insect according to claim 7, wherein the fly repellent is in the form of an emulsion, a powder, a liquid, an ointment, a tincture, a cream, an aerosol or a tablet.

11. A preparation method of the fly repellent according to claim 2, including drying and grounding a by-product of breeding black soldier flies to obtain the fly repellent.

12. A preparation method of the fly repellent according to claim 3, including drying and grounding a by-product of breeding black soldier flies to obtain the fly repellent.

13. A preparation method of the fly repellent according to claim 4, including drying and grounding a by-product of breeding black soldier flies to obtain the fly repellent.

14. A preparation method of the fly repellent according to claim 5, including drying and grounding a by-product of breeding black soldier flies to obtain the fly repellent.

15. A method of repelling a target insect, comprising administering to the target insect an effective amount of the fly-repellent according to claim 2.

16. A method of repelling a target insect, comprising administering to the target insect an effective amount of the fly-repellent according to claim 3.

17. A method of repelling a target insect, comprising administering to the target insect an effective amount of the fly-repellent according to claim 4.

18. A method of repelling a target insect, comprising administering to the target insect an effective amount of the fly-repellent according to claim 5.

19. The method of repelling the target insect according to claim 15, including directly applying more than 50.0 g of the fly repellent on a surface in an environment in which the target insect of the fly repellent is lingering; the surface has an area of 120 cm².

20. The method of repelling the target insect according to claim 15, including applying the fly repellent to a farm environment, an animal body, a human living environment or a food processing factory.
